(19) United States
(12) Patent Application Publication
(10) Pub. No.: US 2016/0039102 A1
(43) Pub. Date: Feb. 11, 2016

(54) RECIPROCATING-TYPE ELECTRIC SHAVER

(71) Applicant: Izumi Products Company, Matsumoto-shi (JP)

(72) Inventor: Tetsuhiko SHIMIZU, Matsumoto-shi (JP)

(73) Assignee: IZUMI PRODUCTS COMPANY, Matsumoto-shi (JP)

(21) Appl. No.: 14/799,399

(22) Filed: Jul. 14, 2015

(30) Foreign Application Priority Data
Aug. 5, 2014 (JP) 2014-159377

(51) Int. Cl. B26B 19/04; B26B 19/38

(52) U.S. Cl. CPC B26B 19/046; B26B 19/3846

(57) ABSTRACT

A reciprocating-type electric shaver includes a head unit that is arranged so as to be capable of oscillating at least forward to and rearward from a main body. The head unit has multiple blade units whose inner blades and come into sliding contact with an inner surface of outer blades and reciprocate rightward and leftward. At least one of the blade units is configured to serve as a movable blade unit which is held by a blade frame of the head unit so as to be vertically movable from the reference position between a predetermined upper position and a predetermined lower position, and the blade frame has a positioning lever which performs positioning by moving the movable blade unit to a desired position.

### CROSS-REFERENCE TO RELATED APPLICATION

This application is based upon and claims the benefit of priority of the prior Japanese Patent Application No. P2014-159377, filed on Aug. 5, 2014, and the entire contents of which are incorporated herein by reference.

### FIELD

The present invention relates to a reciprocating-type electric shaver.

### BACKGROUND

In the related art, a reciprocating-type electric shaver is known in which a head unit has multiple blade units whose inner blade comes into sliding contact with an inner surface of an outer blade and reciprocates rightward and leftward.

For example, PTL 1 discloses a configuration in which the head unit oscillates forward to and rearward from a main body in order to improve shaving quality by allowing the head unit to comfortably fit a user's skin, PTL 1 further discloses a configuration in which a blade unit suitable for a shaving target is moved to a predetermined vertical position from a reference position so as to enable positioning.

### CITATION LIST

### Patent Literature

PTL 1: JP-A-2004-049864

### SUMMARY OF INVENTION

### Technical Problem

Here, according to the reciprocating-type electric shaver disclosed in PTL 1, the head unit can oscillate forward to and rearward from the main body, However, a configuration is adopted in which mechanisms for vertically moving a predetermined blade unit (a mode switching dial, a dial shaft, a link arm, and the like) are arranged in the main body, and in which the mechanisms and the head unit are connected to each other so as to realize a vertical movement of the blade unit. Consequently, the mechanisms inside the main body and the head unit become very complicated, thereby resulting in the increased number of components and the increased number of assembly processes.

The present invention is made in view of the above-described circumstances, and an object thereof is to provide a reciprocating-type electric shaver with a simple mechanism in which a head unit can oscillate forward to and rearward from a main body, and in which at least one blade unit disposed in the head unit is moved to a predetermined vertical position from a reference position so as to enable positioning.

### Solution to Problem

The object may be realized by providing an embodiment disclosed hereinafter.

A disclosed reciprocating-type electric shaver includes a head unit that is arranged so as to be capable of oscillating at least forward to and rearward from a main body. The head unit has multiple blade units whose inner blades come into sliding contact with an inner surface of outer blades and reciprocate rightward and leftward. At least one of the blade units is configured to serve as a movable blade unit which is held by a blade frame of the head unit so as to be vertically movable from a reference position between a predetermined upper position and a predetermined lower position, and the blade frame has a positioning lever which performs positioning by moving the movable blade unit to a desired position.

### Advantageous Effects

According to the present invention, a reciprocating-type electric shaver can be realized in which a simple mechanism enables a head unit to oscillate forward to and rearward from a main body, and in which at least one blade unit disposed in the head unit is moved to a predetermined vertical position from a reference position so as to enable positioning. In addition, since the mechanism can be simplified, it is possible to decrease the number of components and the number of assembly processes.

### BRIEF DESCRIPTION OF THE DRAWINGS

FIG. 1 is a schematic view (perspective view) illustrating an example of a reciprocating-type electric shaver according to an embodiment of the present invention.

FIG. 2 is a schematic view (exploded perspective view) illustrating an example of a head unit in the reciprocating-type electric shaver illustrated in FIG. 1.

FIG. 3 is a schematic view (exploded perspective view) illustrating an example of a blade frame and each blade unit of the head unit in the reciprocating-type electric shaver illustrated in FIG. 1.

FIGS. 4A and 4B are schematic views (exploded perspective view) illustrating an example of a movable blade unit (ordinary blade unit) in the reciprocating-type electric shaver illustrated in FIG. 1.

FIGS. 5A and 5B are schematic views (exploded perspective view) illustrating an example of a movable blade unit (trimmer blade unit) in the reciprocating-type electric shaver illustrated in FIG. 1.

FIG. 6 is a schematic view (exploded perspective view) illustrating an example of an outer trimmer blade assembly and an inner trimmer blade assembly in the trimmer blade unit illustrated in FIGS. 5A and 5B.

FIG. 7 is a schematic view (exploded perspective view) illustrating a main portion of a stationary blade unit (ordinary blade unit) in the reciprocating-type electric shaver illustrated in FIG. 1.

FIG. 8 is a schematic view (exploded perspective view) illustrating a main portion of a stationary blade unit (trimmer blade unit) in the reciprocating-type electric shaver illustrated in FIG. 1.

FIG. 9 is a schematic view (exploded perspective view) illustrating an example of the outer trimmer blade assembly and the inner trimmer blade assembly in the trimmer blade unit illustrated in FIG. 8.

FIGS. 10A to 10F are views for illustrating an operation of the reciprocating-type electric shaver illustrated in FIG. 1.

### DESCRIPTION OF THE EMBODIMENTS

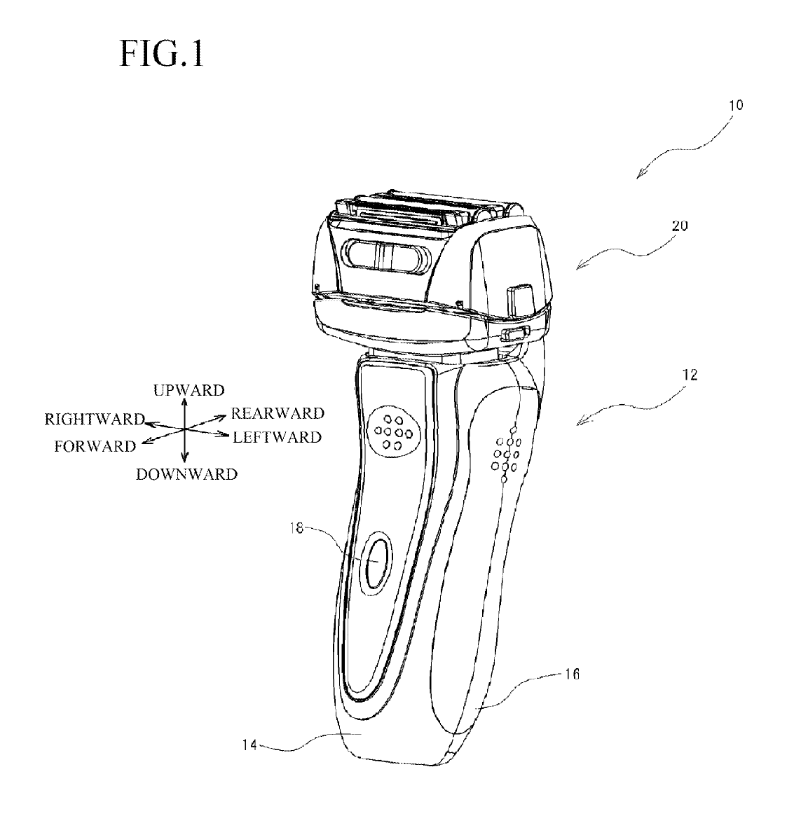

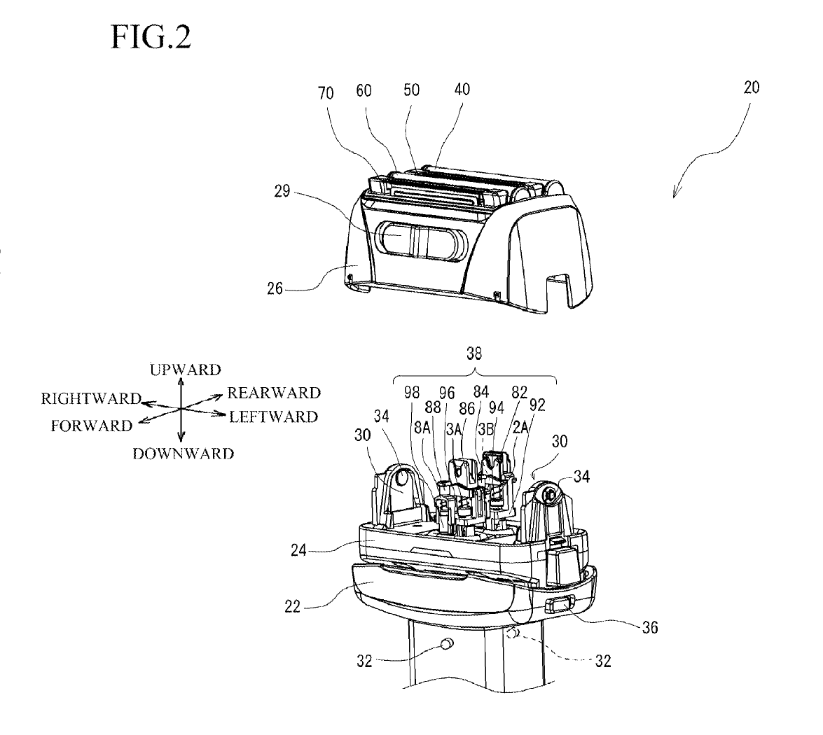

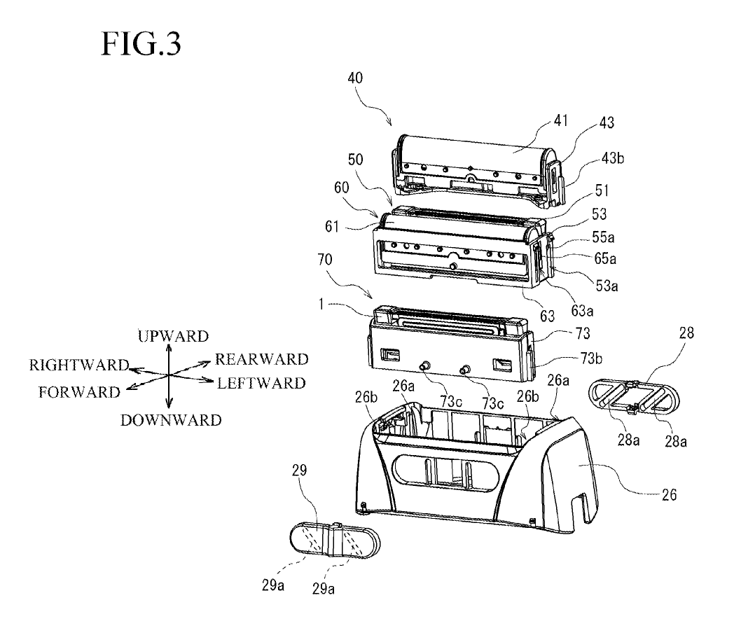

Hereinafter, an embodiment of the present invention will be described in detail with reference to the drawings. FIG. 1 is a schematic view (perspective view) illustrating an example of a reciprocating-type electric shaver 10 according to the present embodiment. In addition, FIG. 2 is a schematic view (exploded perspective view) illustrating an example of a head unit 20 in the reciprocating-type electric shaver 10. In addition, FIG. 3 is a schematic view (exploded perspective view) illustrating an example of a blade frame 26 and respective blade units 40, 50, 60, and 70 of the head unit 20. In order to facilitate description, arrow directions in the drawings respectively indicate forward and rearward directions, rightward and leftward directions, and upward and downward directions of the reciprocating-type electric shaver 10. Referring to all drawings used in describing the embodiment, the same reference numerals are given to members having the same function, and repeated description thereof will be omitted in some cases.

First, a schematic configuration of the reciprocating-type electric shaver 10 according to the present embodiment will be described (refer to FIGS. 1 to 3). The head unit 20 having multiple blade units arrayed by combining an outer blade with an inner blade which comes into sliding contact with an inner surface of the outer blade and reciprocates rightward and leftward is disposed above a main body 12 including a drive mechanism.

The main body 12 internally accommodates a motor for causing the inner blade of the respective blade units 40, 50, 60, and 70 to reciprocate, a battery serving as a power source of the motor, and a control circuit board (all are not illustrated) which performs the drive control of the motor. In addition, a power switch 18 for driving and stopping the motor is disposed on a front surface of the main body 12.

In contrast, the head unit 20 has a blade frame 26 mounted on an upper portion thereof, and the multiple blade units 40, 50, 60, and 70 which are held by the blade frame 26. In addition, the head unit 20 internally has a drive mechanism 38 (to be described later) of the blade units 40, 50, 60, and 70. Among the multiple blade units 40, 50, 60, and 70, at least one blade unit (in the present embodiment, the blade units 40 and 70) is configured to serve as a movable blade unit which can be used by being positioned at (fixed to) a position where the blade unit is vertically moved from a position where a blade surface (upper surface) of the outer blade becomes a reference surface (reference position illustrated by X in FIG. 7) (details to be described later).

In the present embodiment, four blade units 40, 50, 60, and 70 are arrayed. As an example, an ordinary blade unit 40 (rearmost portion), a trimmer blade unit 50, an ordinary blade unit 60, and a trimmer blade unit 70 (foremost portion) are sequentially disposed from the rear side toward the front side. Here, the ordinary blade units 40 and 60 are blade units which are mainly used for ordinary hair and finishing touches in shaving, and the trimmer blade units 50 and 70 are blade units which are mainly used for rough shaving of long hair and coarse hair. In this invention, examples of the hairs include beards, mustaches, whiskers, and the like. The number of blade units to be disposed, a configuration ratio and an arrangement order of the trimmer blade units and the ordinary blade units are not limited to those of the above-described embodiment.

Among the above-described blade units, the ordinary blade unit 40 and the trimmer blade unit 70 are configured to serve as a movable blade unit which can be used by being positioned at (fixed to) a position where the blade units are vertically moved from a position where a blade surface (upper surface) of the outer blade becomes a reference surface (reference position X), as will be described later. In contrast, the ordinary blade unit 60 and the trimmer blade unit 50 are configured to serve as a stationary blade unit which is used by being positioned at (fixed to) a position where the blade surface (upper surface) of the outer blade becomes the reference surface (reference position X). As will be described later, a configuration may be adopted in which the four blade units 40, 50, 60, and 70, when in use, can be slightly slidable and movable in a direction retracting from a position where the respective four blade units 40, 50, 60, and 70 are vertically positioned (fixed).

First, the movable blade unit (the ordinary blade unit 40 and the trimmer blade unit 70) will be described.

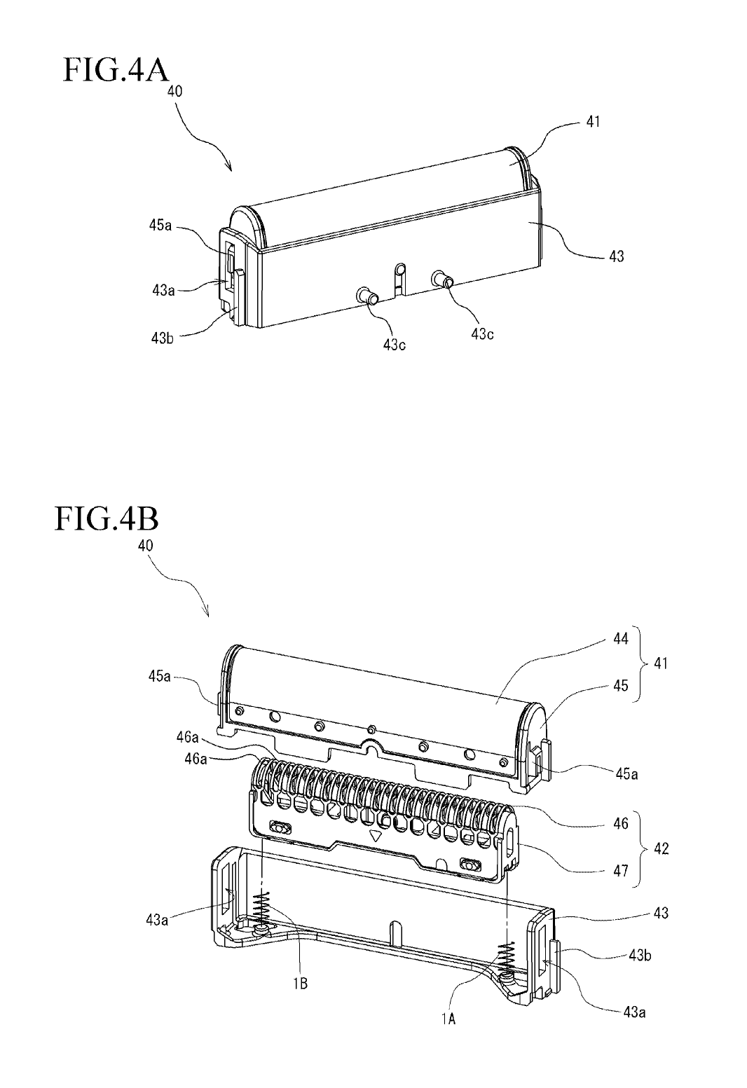

As illustrated in FIGS. 4A and 4B, the ordinary blade unit 40 serving as the movable blade unit is configured to include an outer blade assembly 41, an inner blade assembly 42, and a blade mount 43. FIG. 4A is a perspective view when the ordinary blade unit 40 is viewed from the rear side, and FIG. 4B is an exploded perspective view when the ordinary blade unit 40 is viewed from the front side.

The outer blade assembly 41 adopts a configuration in which an outer blade 44 is fixed to an outer blade base 45. The outer blade 44 is formed by bending a metal plate made of stainless steel and having a predetermined thickness into an arcuate shape, that is, a U-shape (also referred to as an inverted U-shape when the vertical direction is considered) in a cross-sectional view taken along a surface perpendicular to the longitudinal direction (rightward and leftward directions). In the arcuately bent portion (that is, a predetermined top portion and the peripheral portion) of the outer blade 44, multiple apertures (hair inlets) for admitting hair are formed by penetrating the metal plate. In this manner, it is possible to cut the hair entering the hair inlets by interposing the hair between a lower surface (inner surface) of the outer blade 44 and the inner blade 46. The hair inlets can employ various shapes such as a round hole shape, a slit shape, or a combination therebetween.

In contrast, the inner blade assembly 42 adopts a configuration in which an inner blade 46 is fixed to an inner blade base 47. The inner blade 46 is formed by bending a metal plate made of stainless steel and having a predetermined thickness into an arcuate shape, that is, a U-shape (also referred to as an inverted U-shape when the vertical direction is considered) in a cross-sectional view taken along a surface perpendicular to the longitudinal direction (rightward and leftward directions). The inner blade 46 has multiple small blades 46a which have an arcuate shape and are formed integrally with one another. An arcuate upper surface (outer peripheral surface) of the inner blade 46, that is, the respective small blades 46a, is a curved surface which comes into sliding contact with the inner surface of the outer blade 44.

Here, the outer blade assembly 41 is held by the blade mount 43. In this case, the outer blade assembly 41 is held in a state where the inner blade assembly 42 is biased toward the outer blade assembly 41 by first biasing members (for example, coil springs) 1A and 1B arranged in the blade mount 43 so that the inner blade 46 is pressed against the inner surface of the outer blade 44. In addition, the present embodiment adopts a configuration in which a projection 45a of the outer blade base 45 engages with an elongated hole portion 43a of the blade mount 43 so that the outer blade assembly 41 is vertically slidable and movable with respect to the blade mount 43. According to this configuration, the outer blade assembly 41 and the inner blade assembly 42 can be ordinarily held (positioned) at an upper position from the blade mount 43 by the first biasing members 1A and 1B. When the outer blade assembly 41 and the inner blade assembly 42 in use are pressed by skin, the outer blade assembly 41 and the inner blade assembly 42 are slightly (that is, by an amount of the vertical length of the elongated hole 43a) slidable and movable in the direction retracting from the blade mount 43. Without being limited to the coil springs, the first biasing members 1A and 1B may be configured by employing leaf springs (not illustrated). In addition, as a modification example, a configuration may be adopted in which the outer blade assembly 41 is completely fixed to the blade mount 43 so as not to be slidable and movable (not illustrated).

Furthermore, a configuration is adopted in which the blade mount 43 is mounted on the blade frame 26 disposed in the head unit 20 and the blade mount 43 is held so as to be vertically movable by the blade frame 26. More specifically, a projection 43b disposed in both ends in the longitudinal direction (rightward and leftward directions) of the blade mount 43 engages with a vertical groove 26a disposed at the corresponding position inside the blade frame 26. In this manner, the blade mount 43 is held so as not to be movable forward, rearward, rightward, and leftward, and so as to be vertically movable with respect to the blade frame 26. That is, the ordinary blade unit 40 serving as the movable blade unit is vertically movable with respect to the blade frame 26.

Here, according to the present embodiment, the positioning lever 28 which performs positioning by moving the movable blade unit (ordinary blade unit 40) to a desired vertical position is disposed in the blade frame 26 (refer to FIG. 3). More specifically, a configuration is adopted in which the positioning lever 28 is arranged so as to be slidable and movable rightward and leftward with respect to the blade frame 26, and in which the rear surface of the positioning lever 28 has an engagement groove 28a which is formed obliquely upward from below. In contrast, a configuration is adopted in which the blade mount 43 has an engagement projection 43c formed on a surface facing the rear surface of the positioning lever 28, and in which the engagement projection 43c engages with the engagement groove 28a so as to be held by the blade frame 26. Therefore, a configuration of vertically moving the blade mount 43 is realized by slidingly moving the positioning lever 28 rightward and leftward. That is, the blade mount 43, that is, the ordinary blade unit 40 is positioned at a predetermined position by setting the positioning lever 28 to locate at the predetermined position.

According to the above-described configuration, the ordinary blade unit 40 serving as the movable blade unit can be held by the blade frame 26 so as to be vertically movable from the reference position X between a predetermined upper position and a predetermined lower position, and the ordinary blade unit 40 can be positioned by being moved to a desired vertical position. In this case, there is provided a configuration in which the first biasing members 1A and 1B are arranged in the blade mount 43 of the ordinary blade unit 40, and in which the inner blade 46 is pressed against the inner surface of the outer blade 44 by the first biasing members 1A and 1B. Accordingly, even when the ordinary blade unit 40 is vertically moved with respect to the blade frame 26 so as to be positioned at a desired position, it is possible to suppress fluctuations in a pressing force. The fluctuations in the pressing force in a case where the outer blade 44 (outer blade assembly 41) is slidingly moved in the direction retracting from the blade mount 43 fall within a range of no hindrance.

As described above, when the inner blade 46 is pressed against and comes into sliding contact with the inner surface of the outer blade 44 while being driven rightward and leftward, fluctuations in the pressing force can be suppressed, thereby enabling the pressing force to be maintained in an optimum region. As a result, it is possible to prevent an increase in power consumption which is caused by the excessive pressing force, and to prevent an increase in abrasion loss of a sliding contact portion. In addition, it is possible to prevent shaving quality from becoming poor due to the insufficient pressing force.

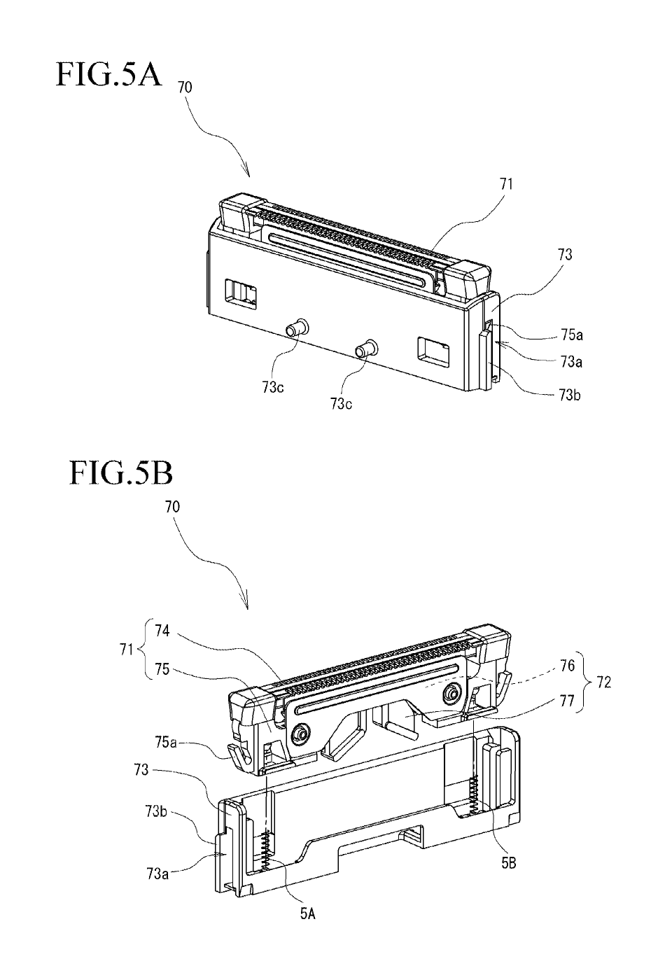

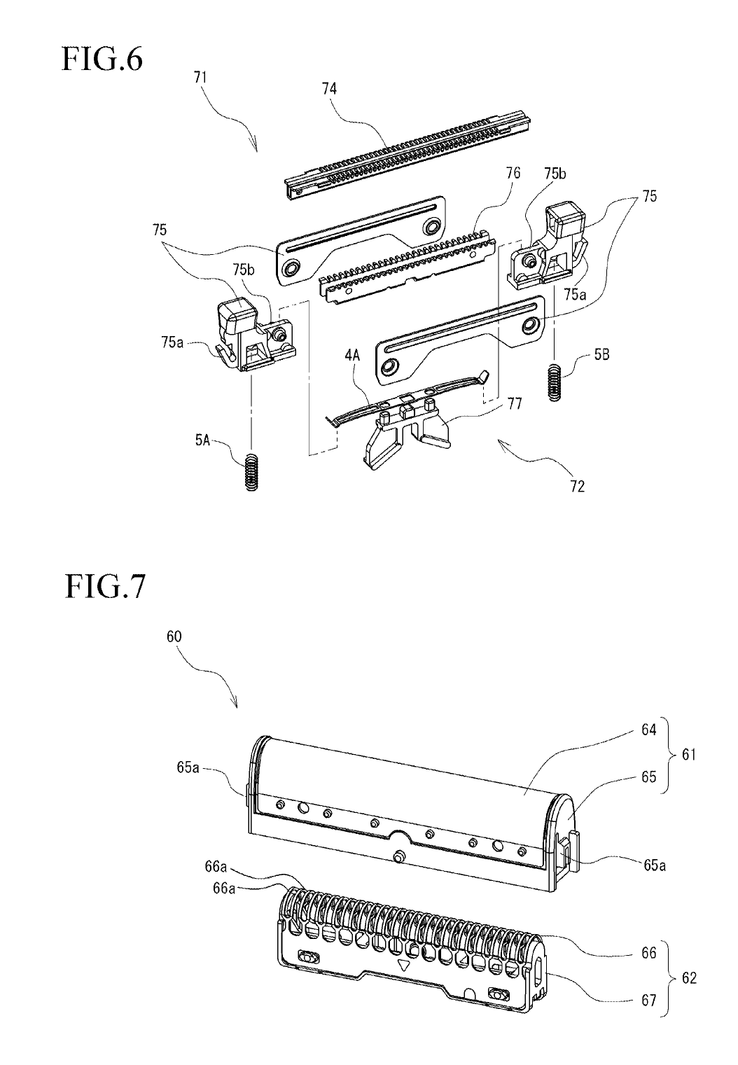

Next, FIGS. 5A and 5B illustrate a configuration of the trimmer blade unit 70 serving as the movable blade unit. The basic configuration of the trimmer blade unit 70 is the same as that of the ordinary blade unit 40. Hereinafter, mainly different points will be described. The trimmer blade unit 70 is configured to include an outer trimmer blade assembly 71 and an inner trimmer blade assembly 72. In a case of the outer trimmer blade assembly 71, an outer trimmer blade 74 whose upper surface has a planar shape such as an L-shape, a U-shape, or a juxtaposed shape therebetween in a cross-sectional view, and which has many slits is fixed to an outer trimmer blade base 75. In a case of the inner trimmer blade assembly 72, an inner trimmer blade 76 which can come into sliding contact with the inner surface (lower surface) of the outer trimmer blade 74, whose upper surface has a planar shape such as an L-shape, a U-shape, or a juxtaposed shape therebetween in a cross-sectional view, and which has many small blades is fixed to an inner trimmer blade base 77. FIG. 5A is a perspective view when the trimmer blade unit 70 is viewed from the front side, and FIG. 5B is an exploded perspective view when the trimmer blade unit 70 is viewed from the rear side. FIG. 6 is an exploded perspective view when the outer trimmer blade assembly 71 and the inner trimmer blade assembly 72 of the trimmer blade unit 70 illustrated in FIG. 5B are viewed from the rear side. As an example, the inner trimmer blade 76 according to the present embodiment has a shape in which two blades having an L-shape (inverted L-shape) in a cross-sectional view are juxtaposed so as to be opposite to each other in the lateral direction (forward and rearward directions).

Here, the inner trimmer blade assembly 72 is held by the outer trimmer blade assembly 71. More specifically, as illustrated in FIG. 6, the inner trimmer blade assembly 72 is held in a state where the inner trimmer blade 76 is biased toward the outer trimmer blade 74 by a fourth biasing member (for example, a leaf spring) 4A so that the upper surface of the inner trimmer blade 76 is pressed against the inner surface (lower surface) of the outer trimmer blade 74. According to the present embodiment, the fourth biasing member 4A is supported on a support portion 75b of the outer trimmer blade base 75, thereby generating a biasing force for biasing the inner trimmer blade 76 in the above-described direction. Without being limited to the leaf spring, the fourth biasing member 4A may be configured to employ a coil spring, or the like (not illustrated).

In addition, as illustrated in FIGS. 5A and 5B, the outer trimmer blade assembly 71 is held by a trimmer blade mount 73. In this case, the outer trimmer blade assembly 71 is held in a state where the outer trimmer blade assembly 71 is biased upward by fifth biasing members (for example, coil springs) 5A and 5B and an eighth biasing member 8A (to be described later) which are arranged in the trimmer blade mount 73. In addition, according to the present embodiment, a configuration is adopted in which a projection 75a of the outer trimmer blade base 75 engages with an elongated hole portion 73a of the trimmer blade mount 73 so that the outer trimmer blade assembly 71 is vertically slidable and movable with respect to the trimmer blade mount 73. Without being limited to the coil springs, the fifth biasing members 5A and 5B may be configured to employ a leaf spring, or the like (not illustrated).

According to this configuration, the outer trimmer blade assembly 71 and the inner trimmer blade assembly 72 can be ordinarily held at (fixed to) the upper position from the trimmer blade mount 73 by the fifth biasing members 5A and 5B and the eighth biasing member 8A. When the outer trimmer blade assembly 71 and the inner trimmer blade assembly 72 in use are pressed by skin, the outer trimmer blade assembly 71 and the inner trimmer blade assembly 72 are slightly (that is, by an amount of the vertical length of the elongated hole 73a) slidable and movable in the direction retracting from the trimmer blade mount 73. As a modification example, a configuration may be adopted in which the outer trimmer blade assembly 71 is completely fixed to the trimmer blade mount 73 so as not to be slidable and movable (not illustrated).

Furthermore, similarly to the ordinary blade unit 40, a configuration is adopted in which the trimmer blade mount 73 is assembled with the blade frame 26 disposed in the head unit 20 and is held so as to be vertically movable by the blade frame 26. More specifically, a projection 73b disposed in both ends in the longitudinal direction (rightward and leftward directions) of the trimmer blade mount 73 engages with a vertical groove 26b disposed at the corresponding position inside the blade frame 26. In this manner, the trimmer blade mount 73 is held so as not to be movable forward, rearward, rightward, and leftward, and so as to be vertically movable with respect to the blade frame 26. That is, the trimmer blade unit 70 serving as the movable blade unit is vertically movable with respect to the blade frame 26.

Here, according to the present embodiment, a positioning lever 29 which performs positioning by moving the movable blade unit (trimmer blade unit 70) to a desired vertical position is disposed in the blade frame 26 (refer to FIG. 3). More specifically, a configuration is adopted in which the positioning lever 29 is arranged so as to be slidable and movable rightward and leftward with respect to the blade frame 26, and in which the rear surface of the positioning lever has an engagement groove 29a which is formed obliquely upward from below. In contrast, a configuration is adopted in which the trimmer blade mount 73 has an engagement projection 73c formed on a surface facing the rear surface of the positioning lever 29, and in which the engagement projection 73c engages with the engagement groove 29a so as to be held by the blade frame 26. Therefore, a configuration of vertically moving the trimmer blade mount 73 is realized by slidingly moving the positioning lever 29 rightward and leftward. That is, the trimmer blade mount 73, that is, the trimmer blade unit 70 is positioned at a predetermined position by setting the positioning lever 29 to locate at the predetermined position.

According to the above-described configuration, the trimmer blade unit 70 serving as the movable blade unit can be held by the blade frame 26 so as to be vertically movable from the reference position X between a predetermined upper position and a predetermined lower position, and the trimmer blade unit 70 can be positioned by being moved to a desired vertical position. In this case, there is provided a configuration in which the inner trimmer blade assembly 72 is held by the outer trimmer blade assembly 71, and in which the inner trimmer blade 76 is pressed against the inner surface of the outer trimmer blade 74 by the fourth biasing member 4A supported by the outer trimmer blade base 75 (support portion 75b) of the outer trimmer blade assembly 71. Accordingly, even when the trimmer blade unit 70 is vertically moved with respect to the blade frame 26 so as to be positioned at a desired position, it is possible to suppress fluctuations in a pressing force between the inner trimmer blade 76 and the outer trimmer blade 74. The fluctuations in the pressing force in a case where the outer trimmer blade 74 (outer trimmer blade assembly 71) is slidingly moved in the direction retracting from the trimmer blade mount 73 fall within a range of no hindrance.

As described above, when the inner trimmer blade 76 is pressed against and comes into sliding contact with the inner surface of the outer trimmer blade 74 while being driven rightward and leftward, fluctuations in the pressing force can be suppressed, thereby enabling the pressing force to be maintained in an optimum region. As a result, it is possible to prevent an increase in power consumption which is caused by the excessive pressing force, and to prevent an increase in abrasion loss of a sliding contact portion. In addition, it is possible to prevent shaving quality from becoming poor due to the insufficient pressing force.

Subsequently, the stationary blade unit (the ordinary blade unit 60 and the trimmer blade unit 50) will be described.

As illustrated in FIGS. 3 and 7, the ordinary blade unit 60 serving as the stationary blade unit is configured to include an outer blade assembly 61, an inner blade assembly 62, and a blade mount 63. The outer blade assembly 61 is configured so that an outer blade 64 made of stainless steel and having a U-shape (also referred to as an inverted U-shape when the vertical direction is considered) in a cross-sectional view is fixed to an outer blade base 65. The basic configuration is the same as that of the above-described ordinary blade unit 40, and repeated description thereof will be omitted.

In contrast, the inner blade assembly 62 is configured so that an inner blade 66 made of stainless steel, having many small blades 66a, and having a U-shape (also referred to as an inverted U-shape when the vertical direction is considered) in a cross-sectional view is fixed to an inner blade base 67. The basic configuration is the same as that of the above-described ordinary blade unit 40, and repeated description thereof will be omitted.

Here, the outer blade assembly 61 is held by the blade mount 63, and the blade mount 63 is held by the blade frame 26 (refer to FIG. 3). However, the ordinary blade unit 60 serving as the stationary blade unit is different from the ordinary blade unit serving as the above-described movable blade unit. The ordinary blade unit 60 is configured not to have the first biasing member for biasing the inner blade 66 so as to be pressed against the inner surface of the outer blade 64. That is, according to the present embodiment, a configuration is adopted in which a drive lever 86 biased upward by a third biasing member 3A (to be described later) causes the inner blade assembly 62 to be biased toward the outer blade assembly 61, and the inner blade 66 is pressed against the inner surface of the outer blade 64, and in which the stationary blade unit (ordinary blade unit 60) is positioned at the reference position X.

According to the present embodiment, a configuration is adopted in which a projection 65a of the outer blade base 65 of the outer blade assembly 61 engages with an elongated hole portion 63a of the blade mount 63. In this manner, the outer blade assembly 61 is vertically slidable and movable with respect to the blade mount 63. According to this configuration, the outer blade 64 and the inner blade 66 can be ordinarily held at the upper position from the blade mount 63 by the third biasing members 3A (to be described later). When the outer blade 64 and the inner blade 66 in use are pressed by skin, the outer blade 64 and the inner blade 66 are slightly (that is, by an amount of the vertical length of the elongated hole 63a) slidable and movable in the direction retracting from the blade mount 63. The blade mount 63 is fixed to the blade frame 26 so as not to be vertically moved.

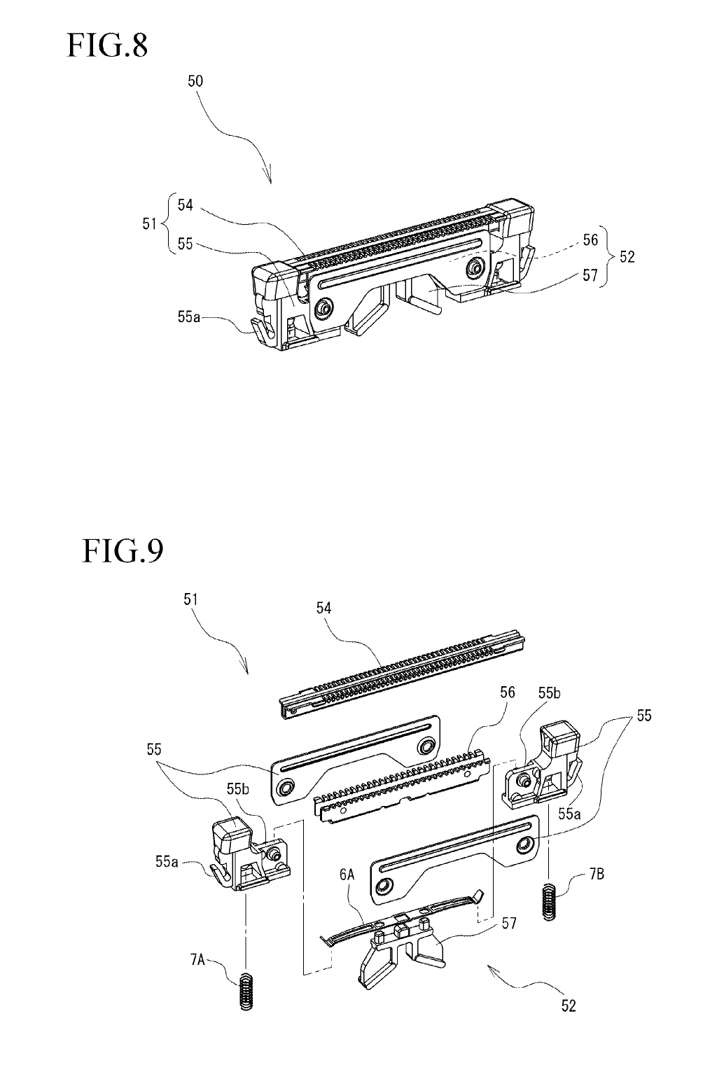

Next, the trimmer blade unit 50 serving as the stationary blade unit will be described (refer to FIGS. 3, 8, and 9). Although the basic configuration of the trimmer blade unit 50 is the same as that of the ordinary blade unit 60, mainly different points will be described herein. FIG. 8 is an exploded perspective view when the trimmer blade unit 50 is viewed from the rear side. FIG. 9 is an exploded view when an outer trimmer blade assembly 51 and an inner trimmer blade assembly 52 of the trimmer blade unit 50 illustrated in FIG. 8 are viewed from the rear side.

The trimmer blade unit 50 is configured to include the outer trimmer blade assembly 51 and the inner trimmer blade assembly 52. In a case of the outer trimmer blade assembly 51, an outer trimmer blade 54 whose upper surface has a planar shape such as an L-shape, a U-shape, or a juxtaposed shape therebetween in a cross-sectional view, and which has many slits is fixed to an outer trimmer blade base 55. In a case of the inner trimmer blade assembly 52, an inner trimmer blade 56 which can come into sliding contact with the inner surface (lower surface) of the above-described outer trimmer blade 54, whose upper surface has a planar shape such as an L-shape, a U-shape, or a juxtaposed shape therebetween in a cross-sectional view, and which has many small blades is fixed to an inner trimmer blade base 57. As an example, the inner trimmer blade 56 according to the present embodiment has a shape in which two blades having an L-shape (inverted L-shape) in a cross-sectional view are juxtaposed so as to be opposite to each other in the lateral direction (forward and rearward directions).

Here, the inner trimmer blade assembly 52 is held by the outer trimmer blade assembly 51. More specifically, as illustrated in FIG. 9, the inner trimmer blade assembly 52 is held in a state where the inner trimmer blade 56 is biased toward the outer trimmer blade 54 by a sixth biasing member (for example, a leaf spring) 6A so that the upper surface of the inner trimmer blade 56 is pressed against the inner surface (lower surface) of the outer trimmer blade 54. According to the present embodiment, the sixth biasing member 6A is supported on a support portion 55b of the outer trimmer blade base 55, thereby generating a biasing force for biasing the inner trimmer blade 56 in the above-described direction. Without being limited to the leaf spring, the sixth biasing member 6A may be configured to employ a coil spring, or the like (not illustrated).

In addition, the outer trimmer blade assembly 51 is held by a trimmer blade mount 53. In this case, the outer trimmer blade assembly 51 is held in a state where the outer trimmer blade assembly 51 is biased upward by seventh biasing members (for example, coil springs) 7A and 7B and the third biasing member 3B (to be described later) which are arranged in the trimmer blade mount 53. Furthermore, the trimmer blade mount 53 is held by the blade frame 26 (refer to FIG. 3). However, the trimmer blade unit 50 serving as the stationary blade unit is different from the trimmer blade unit 70 serving as the above-described movable blade unit. The trimmer blade unit 50 is configured so as to be positioned at a predetermined position, that is, the reference position X without being vertically moved with respect to the blade frame 26. Without being limited to the coil springs, the seventh biasing members 7A and 7B may be configured to employ a leaf spring, or the like (not illustrated).

According to the present embodiment, a configuration is adopted in which a projection 55a of the outer trimmer blade base 55 of the outer trimmer blade assembly 51 engages with an elongated hole portion 53a of the trimmer blade mount 53 so that the outer trimmer blade assembly 51 is vertically slidable and movable with respect to the trimmer blade mount 53. According to this configuration, the outer trimmer blade assembly 51 and the inner trimmer blade assembly 52 can be ordinarily held (positioned) at the upper position from the trimmer blade mount 73 by the seventh biasing members 7A and 7B and the third biasing member 3B. When the outer trimmer blade assembly 51 and the inner trimmer blade assembly 52 in use are pressed by skin, the outer trimmer blade assembly 51 and the inner trimmer blade assembly 52 are slightly (that is, by an amount of the vertical length of the elongated hole 53a) slidable and movable in the direction retracting from the trimmer blade mount 53. As described above, the trimmer blade mount 53 is fixed to the blade frame 26 so as not to be vertically moved.

Here, according to the present embodiment, in order to decrease the number of components, the blade mount 63 and the trimmer blade mount 53 are formed integrally with each other. However, a configuration may be adopted in which both of these are formed as a separated body.

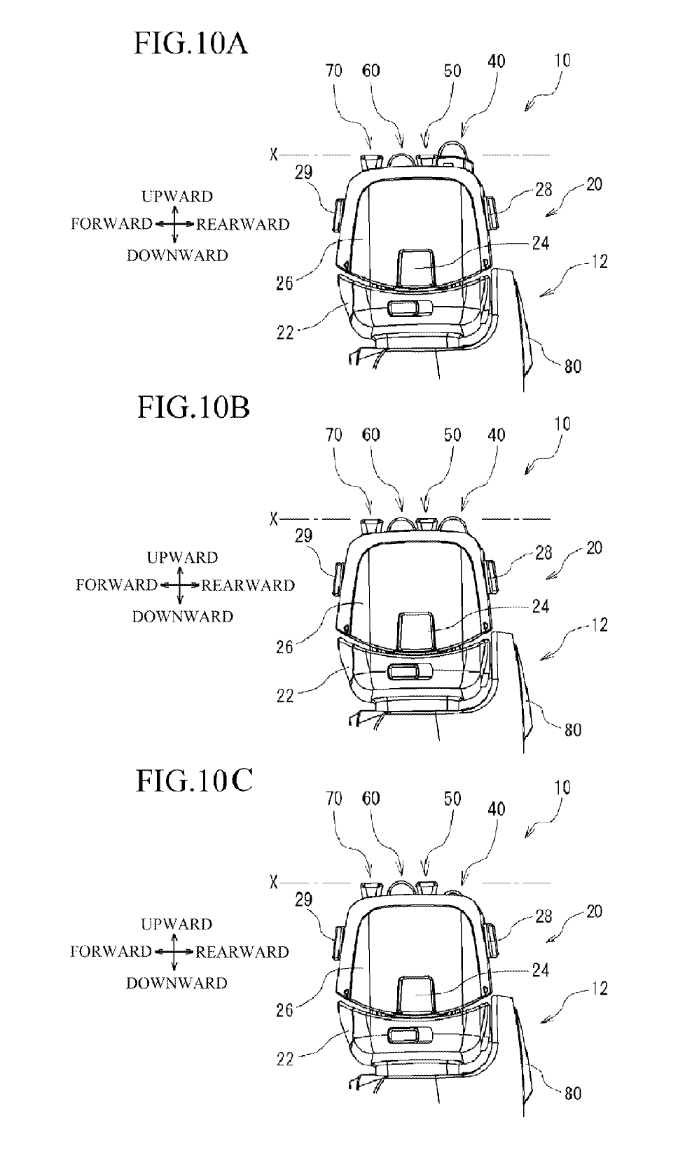

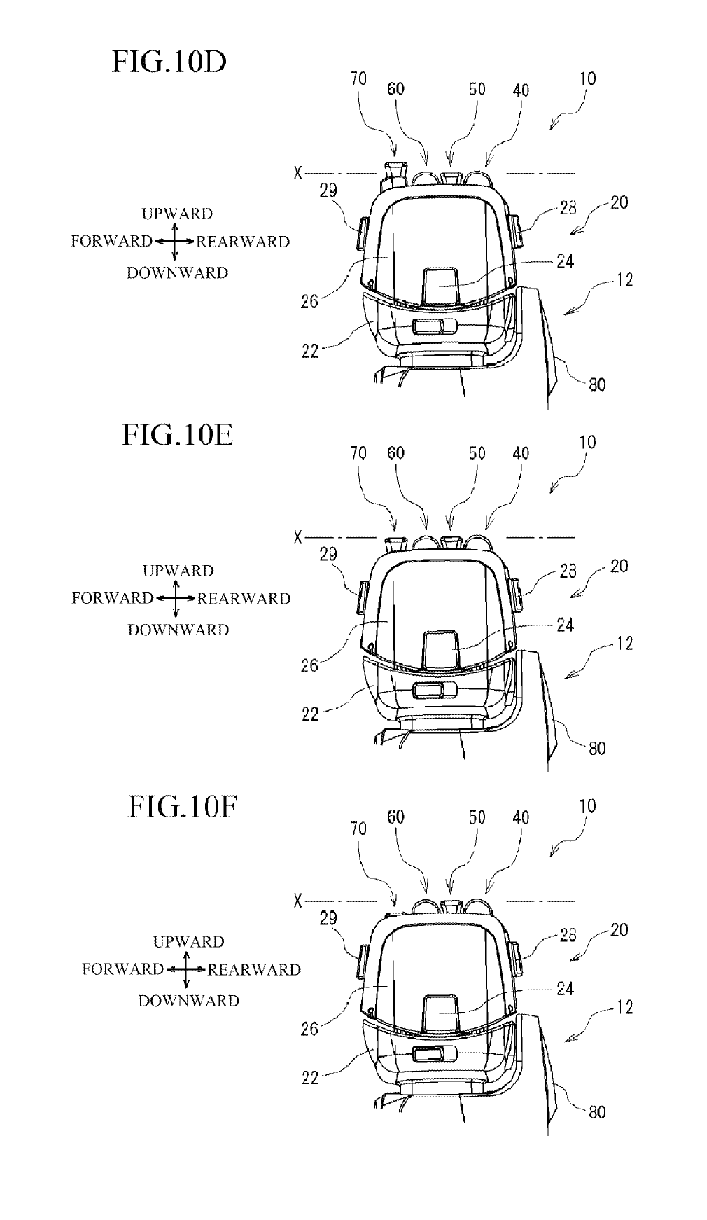

The multiple blade units 40, 50, 60, and 70 which include the above-described configurations can realize various shaving modes (refer to FIGS. 10A to 10F). For example, as illustrated in FIG. 10A, the ordinary blade unit 40 serving as the movable blade unit is used in a state where the ordinary blade unit 40 is moved and positioned (fixed) above the reference position X, thereby providing a mode suitable for shaving under the nose. The reason is that not only a shaving area is limited under the nose, but also a shaving surface under the nose is curved. In addition, as illustrated in FIG. 10B, the ordinary blade unit 40 is used in a state where the ordinary blade unit 40 is positioned at (fixed to) a position which is the same as the reference position X, thereby providing a mode (standard mode) in which a wide area such as the cheek can be quickly shaved by using all blade surfaces (the upper surface of the outer blade and the upper surface of the outer trimmer blade). In addition, as illustrated in FIG. 10C, the ordinary blade unit 40 is used in a state where the ordinary blade unit 40 is moved and positioned (fixed) below the reference position X, thereby providing a mode suitable for capturing coarse hair, since the trimmer blade units 50 and 70 are brought into a state of being arranged in both ends at the reference position X.

In contrast, as illustrated in FIG. 10D, the trimmer blade unit 70 serving as the movable blade unit is used in a state where the trimmer blade unit 70 is moved and positioned (fixed) above the reference position X, thereby providing a mode suitable for shaving hair edges such as sideburns. Therefore, as will be described later, a configuration of omitting a hair edge shaving blade 110 can be adopted. In addition, as illustrated in FIG. 10E, in a state where the trimmer blade unit 70 is positioned at (fixed to) a position which is the same as the reference position X, there is provided a mode which is the same as the above-described standard mode. In addition, as illustrated in FIG. 10F, the trimmer blade unit 70 is used in a state where the trimmer blade unit 70 is moved and positioned (fixed) below the reference position X, thereby providing a mode suitable for shaving hair in a slightly narrow area or for finishing touches in shaving, since the trimmer blade units 40 and 60 are brought into a state of being arranged in both ends at the reference position X.

Subsequently, the main body 12 and the head unit 20 will be described in detail.

The main body 12 includes a configuration in which a front case 14 and a rear case 16 which respectively have a substantially shell shape are superimposed on and joined to each other in peripheral edges thereof.

The reference numeral 80 illustrated in the rear case 16 represents a hair edge shaving blade (refer to FIGS. 10A to 10F). A configuration thereof and an operation thereof are the same as those of the known hair edge shaving blade. Here, according to the present embodiment, the trimmer blade unit 70 serving as the movable blade unit when in use is moved and fixed above the reference position X, thereby enabling hair edge shaving. Accordingly, it is also possible to adopt a configuration of omitting the hair edge shaving blade 80.

In contrast, the head unit 20 is configured to include a rightward-leftward oscillator 22 which is held by the main body 12 so as to be capable of oscillating rightward and leftward with respect to the main body 12, a forward-rearward oscillator 24 which is held by the rightward-leftward oscillator 22 so as to be capable of oscillating forward and rearward with respect to the main body 12, and the blade frame 26 which is fixed so as to cover the forward-rearward oscillator 24 from above. As described above, a configuration is adopted in which the multiple blade units 40, 50, 60, and 70 are held by the blade frame 26, and in which the inner blades 46, 56, 66, and 76 of the respective blade units 40, 50, 60, and 70 are driven by being connected to the drive mechanism 38 (to be described later) arranged in the head unit 20 (here, the forward-rearward oscillator 24).

Here, the rightward-leftward oscillator 22 of the head unit 20 has a substantially cup shape which is elongated rightward and leftward, and a pair of right and left support arms 30 and 30 are disposed to erect in the upper portion of the rightward-leftward oscillator 22. In addition, projections 32 and 32 which project from the front and rear surfaces are formed in the lower portion thereof. The projections 32 and 32 serve as a pivot portion which supports the rightward-leftward oscillator 22 so as to be capable of oscillating rightward and leftward with respect to the main body 12. That is, the projections 32 and 32 serving as the pivot portion function as a fulcrum (pivot point) of rightward and leftward oscillation of the head unit 20. The projections 32 and 32 are covered with vibration-proof rubber (not illustrated).

In contrast, the forward-rearward oscillator 24 of the head unit 20 is supported by the support arms 30 and 30 of the rightward-leftward oscillator 22 so as to be capable of oscillating forward and rearward. Specifically, the forward-rearward oscillator 24 is connected to the support arms 30 and 30 by using pins 34 and 34, and oscillates forward and rearward around the pins 34 and 34. That is, the pins 34 and 34 function as a fulcrum (pivot point) of forward and rearward oscillation of the head unit 20.

A lock button 36 may be disposed in order to lock the forward-rearward oscillator 24 so as not to oscillate with respect to the rightward-leftward oscillator 22. According to this configuration, the forward-rearward oscillator 24 can be set to be in a state where the forward-rearward oscillator 24 does not oscillate forward and rearward. Therefore, when the movable blade unit is used by being vertically moved at a position other than the reference position X, it is possible to stably perform the hair edge shaving.

Since the head unit 20 includes the above-described configurations, the head unit 20 is configured to be capable of oscillating in the rightward and leftward directions, and in the forward and rearward directions. The outer blades 44 and 64, and the outer trimmer blades 54 and 74 in the respective blade units 40, 50, 60, and 70 can be moved while closely fitting a user's skin. Accordingly, it is possible to achieve comfortable shaving quality.

However, the head unit 20 is configured to be capable of oscillating with respect to the main body 12 in the rightward and leftward directions, and in the forward and rearward directions. For this reason, there is a problem of how to realize a simple configuration of the movable blade unit which vertically moves in the head unit 20.

In order to solve this problem, the present embodiment proposes a configuration in which mechanisms (the above-described positioning levers 28, 29, and the like) for vertically moving the movable blade unit (the ordinary blade unit 40 and the trimmer blade unit 70) are disposed in the blade frame 26 as described above. The present embodiment also proposes the characterized drive mechanism 38 for driving the movable blade unit which is vertically moved. In this manner, the problem can be solved. Hereinafter, the drive mechanism 38 will be described in detail.

The drive mechanism 38 has drive levers 82, 84, 86, and 88 which respectively engage with the inner blades 46, 56, 76, and 86, and vibrators 92, 94, 96, and 98 which cause the drive levers 82, 84, 86, and 88 to reciprocate rightward and leftward. The drive mechanism 38 is arranged in the forward-rearward oscillator 24. The vibrators 92, 94, 96, and 98 engage with a crank-shaped cam shaft which is fixed to a rotary shaft of a motor (all are not illustrated), and vibrate rightward and leftward by the motor being rotatably driven. A configuration is adopted in which the drive levers 82, 84, 86, and 88 are respectively mounted on the upper portion of the vibrators 92, 94, 96, and 98 so as to be vertically movable.

Here, the drive lever 82 drives the ordinary blade unit 40 serving as the movable blade unit. The drive lever 82 is biased upward by the second biasing member (as an example, a coil spring) 2A, and is held by the vibrator 92. According to this configuration, the inner blade 46 of the ordinary blade unit 40 is connected to the drive lever 82 so as to be driven to reciprocate rightward and leftward.

In addition, the drive lever 88 drives the trimmer blade unit 70 serving as the movable blade unit. The drive lever 88 is biased upward by the eighth biasing member (as an example, a coil spring) 8A, and is held by the vibrator 98. According to this configuration, the inner trimmer blade 76 of the trimmer blade unit 70 is connected to the drive lever 88 so as to be driven to reciprocate rightward and leftward.

In contrast, the drive lever 86 drives the ordinary blade unit 60 serving as the stationary blade unit. The drive lever 86 is biased upward by the third biasing member (as an example, a coil spring) 3A, and is held by the vibrator 96. According to this configuration, the inner blade 66 of the ordinary blade unit 60 is connected to the drive lever 86 so as to be driven to reciprocate rightward and leftward.

In addition, the drive lever 84 drives the trimmer blade unit 50 serving as the stationary blade unit. The drive lever 84 is biased upward by the third biasing member (as an example, a coil spring) 3B, and is held by the vibrator 94. According to this configuration, the inner trimmer blade 56 of the trimmer blade unit 50 is connected to the drive lever 84 so as to be driven to reciprocate rightward and leftward.

Here, with regard to the ordinary blade unit 40 serving as the movable blade unit, a configuration is adopted in which the inner blade 46 is pressed against the outer blade 44 by the first biasing members 1A and 1B. An optimum pressing force (sliding contact force) is set by the first biasing members 1A and 1B. Therefore, if a biasing force of the second biasing member 2A which biases the drive lever 82 upward is set to be strong, there occurs a problem of the excessive pressing force between the inner blade 46 and the outer blade 44. For this reason, when the ordinary blade unit 40 serving as the movable blade unit is vertically moved, the biasing force of the second biasing member 2A is set to a weak biasing force to an extent such that the drive lever 82 connected to the inner blade 46 can follow the vertical movement.

In addition, with regard to the trimmer blade unit 70 serving as the movable blade unit, a configuration is adopted in which the inner trimmer blade 76 is pressed against the outer trimmer blade 74 by the fourth biasing member 4A. An optimum pressing force (sliding contact force) is set by the fourth biasing member 4A. Therefore, if a biasing force of the eighth biasing member 8A which biases the drive lever 88 upward is set to be strong, there occurs a problem of the excessive pressing force between the inner trimmer blade 76 and the outer trimmer blade 74. For this reason, when the trimmer blade unit 70 serving as the movable blade unit is vertically moved, the biasing force of the eighth biasing member 8A is set to a weak biasing force to an extent such that the drive lever 88 connected to the inner trimmer blade 76 can follow the vertical movement.

In contrast, with regard to the ordinary blade unit 60 serving as the stationary blade unit, a configuration is adopted which does not have the first biasing members 1A and 1B, unlike the movable blade unit. Accordingly, the inner blade 66 is pressed against the outer blade 64, and an optimum pressing force (sliding contact force) is set by the third biasing member 3A. Therefore, if a biasing force of the third biasing member 3A is set to be weak, there occurs a problem of the insufficient pressing force between the inner blade 66 and the outer blade 64. For this reason, the biasing force of the third biasing member 3A is set to a biasing force which is relatively stronger than the above-described biasing force of the second biasing member 2A.

In addition, with regard to the trimmer blade unit 50 serving as the stationary blade unit, a configuration is adopted in which the inner trimmer blade 56 is pressed against the outer trimmer blade 54 by the sixth biasing member 6A. An optimum pressing force (sliding contact force) is set by the sixth biasing member 6A. Therefore, if a biasing force of the third biasing member 3B which biases the drive lever 84 upward is set to be strong, there occurs a problem of the excessive pressing force between the inner trimmer blade 56 and the outer trimmer blade 54. For this reason, when the trimmer blade unit 50 in use is pressed by a user's skin and is slightly slidingly moved in the direction retracting from the trimmer blade mount 53, the biasing force of the third biasing member 3B is set to a weak biasing force to an extent such that the drive lever 84 connected to the inner trimmer blade 56 can follow the sliding movement.

The second biasing member 2A, the third biasing members 3A and 3B, and the eighth biasing member 8A may be configured to employ a leaf spring without being limited to the coil spring (not illustrated).

As described above, according to the reciprocating-type electric shaver 10 of the present invention, a configuration is adopted in which the head unit 20 can oscillate in the rightward and leftward directions and in the forward and rearward direction with respect to the main body 12. Accordingly, the configuration allows the head unit 20 to comfortably fit a user's skin, and thus it is possible to realize favorable shaving quality. In addition, the reciprocating-type electric shaver 10 includes the movable blade unit (the ordinary blade unit 40 and the trimmer blade unit 70), and thus it is possible to realize various shaving modes. Furthermore, a very simple configuration can realize the movable blade unit (the ordinary blade unit 40 and the trimmer blade unit 70) which is vertically moved in the head unit 20. Accordingly, it is possible to decrease the number of components and the number of assembly processes. In addition, when the movable blade unit (the ordinary blade unit 40 and the trimmer blade unit 70) is vertically moved, it is possible to prevent the pressing force between the inner blade 46 and the outer blade 44 and the pressing force between the inner trimmer blade 76 and the outer trimmer blade 74 from becoming excessive or insufficient. Therefore, it is possible to realize favorable shaving quality.

Without being limited to the above-described embodiment, the present invention can be modified in various ways within the scope not departing from the concept of the present invention. In particular, although the reciprocating-type electric shaver having four sets of blade units has been described as an example, the present invention is not limited thereto. In addition, the movable blade unit can be optionally set, and the ordinary blade unit and the trimmer blade unit can also be optionally combined with each other. The present invention can also be applied to a configuration in which the head unit does not oscillate.

1. A reciprocating-type electric shaver, comprising:
a head unit that is arranged so as to be capable of oscillating at least forward to and rearward from a main body,
wherein the head unit has multiple blade units whose inner blades come into sliding contact with an inner surface of outer blades and reciprocate rightward and leftward, and
wherein at least one of the blade units is configured to serve as a movable blade unit which is held by a blade frame of the head unit so as to be vertically movable from a reference position between a predetermined upper position and a predetermined lower position, and the blade frame has a positioning lever which performs positioning by moving the movable blade unit to a desired position.

2. The reciprocating-type electric shaver according to claim 1,
wherein the movable blade unit has a configuration in which the outer blade is held by a blade mount, and in which the inner blade is held while being pressed against an inner surface of the outer blade by first biasing members arranged in the blade mount, and
wherein the blade mount is held so as to be vertically movable by the blade frame.

3. The reciprocating-type electric shaver according to claim 2,
wherein the head unit has a drive lever which engages with the inner blade, and a vibrator which causes the drive lever to reciprocate rightward and leftward, and
wherein the drive lever is held so as to be vertically movable by the vibrator in a state where the drive lever is biased upward by a second biasing member arranged in the vibrator.

4. The reciprocating-type electric shaver according to claim 2,
wherein the positioning lever is arranged so as to be movable rightward and leftward from the blade frame, and a rear surface of the positioning lever has an engagement groove which is formed obliquely upward from below,
wherein the blade mount has an engagement projection formed on a surface facing the rear surface of the positioning lever, and is held by the blade frame so that the engagement projection engages with the engagement groove, and
wherein the blade mount is vertically moved by moving the positioning lever rightward and leftward.

5. The reciprocating-type electric shaver according to claim 3,
wherein the positioning lever is arranged so as to be movable rightward and leftward from the blade frame, and a rear surface of the positioning lever has an engagement groove which is formed obliquely upward from below,
wherein the blade mount has an engagement projection formed on a surface facing the rear surface of the positioning lever, and is held by the blade frame so that the engagement projection engages with the engagement groove, and
wherein the blade mount is vertically moved by moving the positioning lever rightward and leftward.

6. The reciprocating-type electric shaver according to claim 1,
wherein the movable blade unit is arranged in the foremost portion, in the rearmost portion, or in both portions of the head unit.

7. The reciprocating-type electric shaver according to claim 2,
wherein the movable blade unit is arranged in the foremost portion, in the rearmost portion, or in both portions of the head unit.

8. The reciprocating-type electric shaver according to claim 3, wherein the movable blade unit is arranged in the foremost portion, in the rearmost portion, or in both portions of the head unit.

9. The reciprocating-type electric shaver according to claim 4,
wherein the movable blade unit is arranged in the foremost portion, in the rearmost portion, or in both portions of the head unit.

10. The reciprocating-type electric shaver according to claim 5,
wherein the movable blade unit is arranged in the foremost portion, in the rearmost portion, or in both portions of the head unit.

11. The reciprocating-type electric shaver according to claim 1,
wherein the movable blade unit is configured to serve as any one or both of an ordinary blade unit having the inner blade and the outer blade which have an inverted U-shape in a cross-sectional view, and a trimmer blade unit having an inner trimmer blade and an outer trimmer blade whose upper surfaces are respectively planar.
